(19) United States
(12) Patent Application Publication
(10) Pub. No.: US 2012/0311243 A1
(43) Pub. Date: Dec. 6, 2012

(54) METHOD FOR INCREASING RELIABILITY OF DATA ACCESSING FOR A MULTI-LEVEL CELL TYPE NON-VOLATILE MEMORY

(75) Inventor: Chanson Lin, Hsinchu County (TW)

(73) Assignee: ITE TECH. INC., Hsinchu (TW)

(21) Appl. No.: 13/491,601

(22) Filed: Jun. 8, 2012

Related U.S. Application Data
(63) Continuation-in-part of application No. 12/230,661, filed on Sep. 3, 2008, now abandoned.

(30) Foreign Application Priority Data
May 30, 2008 (TW) 097120212

(51) Int. Cl. G06F 12/02

(52) U.S. Cl. 711/103; 711/E12.008

(57) ABSTRACT

The primary object of the present invention is to provide a data accessing method for a multi level cell type non-volatile memory, including a plurality of storage cells, each storage cell has 0^{th}˜M^{th} bits, each K^{th} bit of the storage cells respectively form a K^{th} order bit page, wherein 0≦K≦M, the data accessing method comprising: mapping a logical page onto a plurality of physical pages when a computer system is going to access the multi-level cell type non-volatile memory; taking a plurality of temporary data storage blocks of the multi-level cell type non-volatile memory For data accessing by the computer system based on the multi-level cell type non-volatile memory; and providing a page jumper to only select the K^{th} order bit page of physical pages to store in one temporary data storage block.

### FIELD OF THE INVENTION

The present invention relates to a method for increasing reliability of data accessing for a multi-level cell type non-volatile memory, and more particularly to a method by which specific data storage pages are selected and stored in at least one data storage block by page jumping of a page jumper during data accessing of a computer system, thus the life of use of the memory can be elongated to assure integrity of the data in accessing.

### Description of the Prior Art

NAND flash memories have the characteristics of little writing and erasing cycles, high density (large storage space) and low cost of manufacturing; by virtue that their I/O interfaces only allow continuous reading, they do not suit storing for computers, but do very much suit application on storage cards. Except storage cards which have been used in large amount, cell phones, MP3 players and digital multi-medium players have also been used in large amount as media for storing multi-medium files.

NAND flash memories are divided into two kinds of storing structures, i.e., the Single Level Cell (SLC) and Multi-level Cell (MLC). In the modes of using cells, an SLC flash memory is the same as an EEPROM, but the oxidized thin films in its floating gate and the source are thinner. After data writing into the SLC flash memory, by adding voltage to the electric charges of the floating gate, the electric charges stored can be erased through the source. With such mode, a data bit is stored (1 means erasing, 0 means writing). While an MLC flash memory uses electric; charges of different levels in the floating gate, thereby a single transistor can be stored therein with information of multiple bits, and through the control of writing and sensing of the cells, the single transistor creates a multi-layer state.

Taking a 4LC flash memory as an example, a cell including two bits of which the smaller one is the least significant bit (LSE) while the larger one is the most significant bit (MSB) is be to create a 4 layer state (00, 01, 11, 10) to be written into different pages of a block. Wherein, as shown in FIG. 6, the two bits (LSB, MSB) of each cell (Y0, Y1, Y2, . . . ) are written respectively in the LSB and MSB pages of the block. When in programming the Y0 bit of the LSB page, the voltage level of the cell will change that influence the Y0 bit of the MSB page. Similarly, in programming the Y0 bit of the MSB page, the Y0 bit of the LSB page will change as well.

In the process of data accessing, the computer system writes from the LSB page, and continuing on the MSB page. In writing in the MSB page, if an abnormal system power breaking is induced by abnormally plugging unplugging or the exhausting of a battery, the MSB page and the data originally written in the LSB page will damage at the same time. Perhaps such a problem may have minor influence to a NAND flash memory during a 90 nm manufacturing process; however, as the reducing of the manufacturing process, once an abnormal system power breaking is induced, it is subjected to creating damages and hard to remedy. As is shown in FIG. 7A, after writing the page 0 and page 1 of the LSB page in the structure of a 70 nm manufacturing process, page 2 and page 3 of the MSB page are writing. Or as is shown in FIG. 7B, after writing the page 0, page 1 and page 3 of the LSB page in the structure of a 50 nm manufacturing process, pages 4, 5, 6 and page 7 of the MSB page are writing. Such that, data similarity among pages 0-3, or among pages 4-7 in the 50 nm manufacturing process is usually low, and even there are stored different files.

Additionally, for SLC and MLC flash memories, stability and complexity in storing 1 bit and multiple bits for cells of same capacity are different; an SLC flash memory is more stable than an MLC flash memory, and the speed of writing in the SLC flash memory is faster than that of the MLC flash memory. Although the MLC flash memory having multiple bits can increase storing capability, by an inherent physical limitation, theoretically, number of times of writing on the SLC flash memory is 100,000/block; the life of use of the SLC flash memory is ten times over that of the MLC flash memory having times of writing of only 10,000 times/block; i.e., the life of use of the MLC flash memory is shorter than that of the SLC flash memory.

In view of this, and for eliminating the above defects, the method for increasing reliability of data accessing for a multi-level cell type non-volatile memory not only can reduce the frequency of erasing of flash memory blocks to elongate the life of use of the multi-level cell type non-volatile memory, but also can assure integrity of the data in accessing.

### SUMMARY OF THE INVENTION

The primary object of the present invention is to provide a data accessing method for a multi level cell type non-volatile memory, including a plurality of storage cells, each storage cell has 0^{th}˜M^{th} bits, each K^{th} bit of the storage cells respectively form a K^{th} order bit page, wherein 0≦K≦M, the data accessing method comprising: mapping a logical page onto a plurality of physical pages when a computer system is going to access the multi-level cell type non-volatile memory; taking a plurality of temporary data storage blocks of the multi-level cell type non-volatile memory For data accessing by the computer system based on the multi-level cell type non-volatile memory; and providing a page jumper to only select the K^{th} order bit page of physical pages to store in one temporary data storage block.

The secondary object of the present invention is to provide a data accessing method for a multi level cell type non-volatile memory, including a plurality of storage cells, each storage cell has 0^{th}˜M^{th} bits, each K^{th} bit of the storage cells respectively form a K^{th} order bit page, wherein 0≦K≦M, the data accessing method comprising: mapping a logical page onto a plurality of physical pages when a computer system is going to access the multi-level cell type non-volatile memory; taking a data storage block to store each 0^{th}˜M^{th} order bit pages; taking a plurality of data backup blocks of the multi-level cell type non-volatile memory for data accessing by the computer system based on the multi-level cell type non-volatile memory; and providing a page jumper to only select the K^{th} order bit page of physical pages to store in one data backup block.

The present invention will be apparent after reading the detailed description of the preferred embodiment thereof in reference to the accompanying drawings.

### BRIEF DESCRIPTION OF THE DRAWINGS

FIG. 1 is a flow chart showing a preferred embodiment of the present invention;

FIG. 2 is a schematic block diagram of the preferred embodiment of the present invention;

FIG. 3 is a schematic block diagram showing actions in data storing of the preferred embodiment of the present invention;

FIG. 4 is a schematic block diagram of the present invention showing a page jumper keeping a bypass;

FIG. 5 is a schematic block diagram of another preferred embodiment of the present invention;

FIG. 6 is a schematic diagram showing a data storage skeleton of a 4LC flash memory of the present invention;

FIG. 7 is a schematic diagram of a data storage skeleton of a 4LC flash memory in a 70 nm manufacturing process;

FIG. 7B is a schematic diagram of a data storage skeleton of a 4LC flash memory in a 50 nm manufacturing process;

FIG. 8 is a schematic diagram of a data storage skeleton of a conventional 8LC flash memory.

### DETAILED DESCRIPTION OF THE PREFERRED EMBODIMENT

As a person skilled in the art can know, any multi-level cell type (MLC) non-volatile memory is Formed by combining a plurality of storage cells in array, any storage cell has n bits, and the MLC non-volatile memory is divided into a plurality of data storage blocks, each data storage block is further divided into a plurality of data storage pages. A data storage block is a minimum unit for executing data erasing; and a data storage page is a minimum unit for executing data programming.

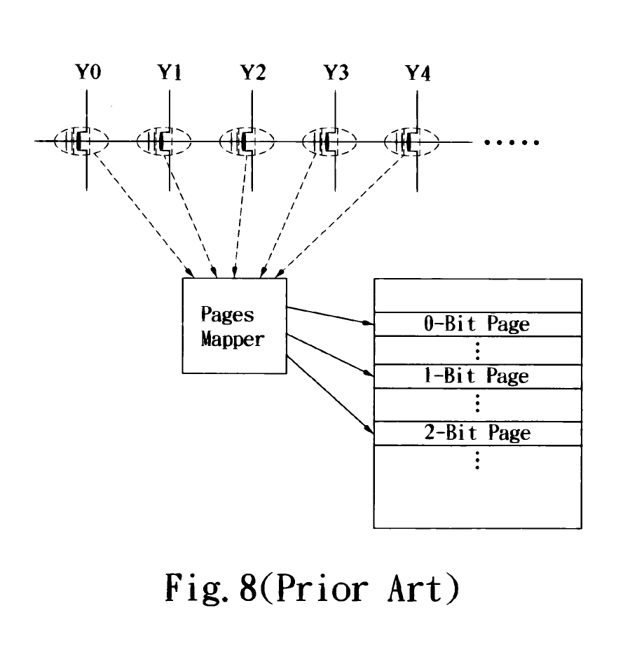

Taking an 8LC (Level Cell) non-volatile memory as an example, generally speaking and as shown in FIG. 8, each storage cell (Y0, Y1 . . . ) of the MLC non-volatile memory has 3 bits (0^{th}, 1^{st}, 2 bit). When a computer system is accessing data from the MLC non-volatile memory, a logical address is mapped onto 3 physical addresses (0^{th}, 1^{st}, 2^{nd} bit) by a mapper, so that a logical page is mapped onto 3 physical pages. In other words, the 0^{th} bit of each storage cell respectively form a 0^{th} order bit page, the 1^{st} bit of each storage cell respectively form a 1^{st} order bit page and the 2^{nd} bit of each storage cell respectively form a 2^{nd} order bit page. Wherein, each data storage block of the 8LC non-volatile memory includes 48 data storage pages. However, as a person skilled in the art can know, a data storage block may have any number of pages, which depends on the size of the non-volatile memory.

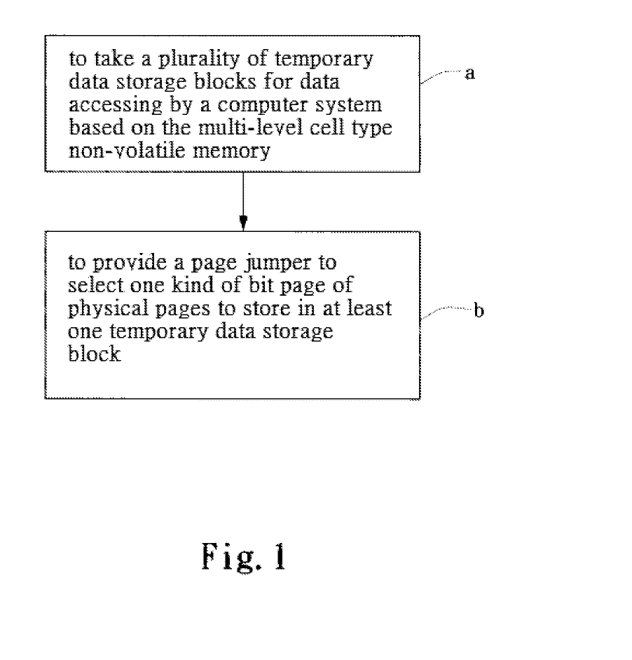

Referring to FIG. 1 showing a preferred embodiment of the method for increasing reliability of data accessing for a multi-level cell type non-volatile memory, it is used in process of data accessing of a computer system for the data storage blocks. The method includes the following steps:
a. to take a plurality of temporary data storage blocks for data accessing by a computer system based on the multi-level cell type non-volatile memory; and
b. to provide a page jumper to select one kind of bit page of physical pages to store in at least one temporary data storage block.

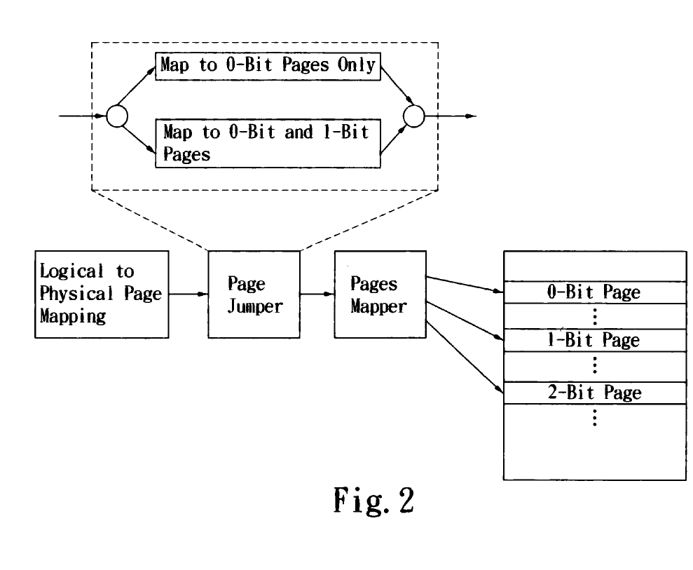

Referring to FIG. 2 which is a schematic block diagram of a first preferred embodiment of the present invention, a MLC non-volatile memory includes a logical-to-physical page element, a page jumper and a page mapper. The logical-to-physical page element is coupled to the page jumper, and the page jumper is coupled to the page mapper. When a computer system is going to access the MLC non-volatile memory, a logical page is mapped onto physical pages first by the logical-to-physical page element. In accordance with the first embodiment, a plurality of temporary data storage blocks are taken and only one kind of bit page of physical pages is stored in one temporary data storage block.

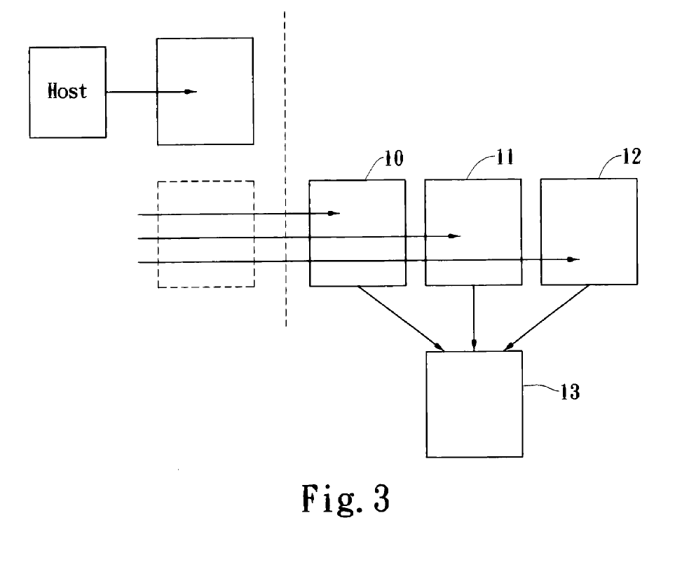

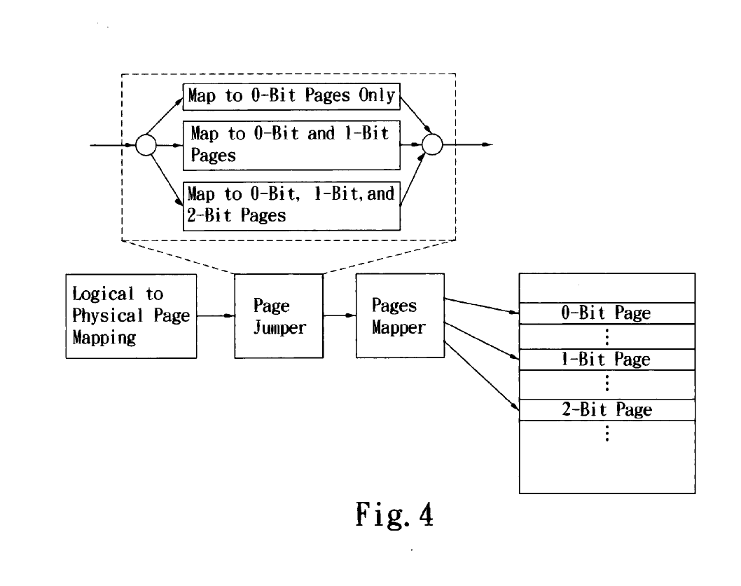

Pease refer to FIG. 1, FIG. 2 and FIG. 3, which take the 8LC non-volatile memory as an example. In the step a, three data storage blocks are regarded as temporary data storage blocks (10, 11, 12) of a host, such as a computer system. In the step b, when the computer system is writing data to the 8LC non-volatile memory, a logical page is mapped onto 3 physical pages by the logical-to-physical page element, and the page jumper only selects the 0^{th} order bit page which is formed from the 0^{th} bit of storage cells to store in the temporary data storage block 10, and the page jumper only selects the 1^{st} order bit page which is formed from the 1^{st} bit of storage cells to store in the temporary data storage block 11, and the page jumper only selects the 2^{nd} order bit page which is formed from the 2^{nd} bit of storage cells to store in the temporary data storage block 12. In short, each temporary data storage block is used to store one kind of bit page because the jumping of the page jumper. Besides, the mapping relation is performed by the page mapper. After the computer system writes all data to the 48 pages of temporary data storage blocks (10, 11, 12), and changes to another temporary data storage block (not shown in FIG. 3), the data stored in the temporary data storage blocks (10, 11, 12) are merged in a clean block 13. Then a data storage block having no page jumping, i.e. the dean block 13, is formed, and the mapping is remapped by the page mapper. The data stored in these temporary data storage blocks (10, 11, 12) are erased. In operation, the temporary data storage blocks (10, 11, 12) are clean blocks, however, they may applied to blocks having stored some data. Besides, the page jumper may also applied as selecting both the 0^{th} order bit page and the 1^{st} order bit page formed from the 0^{th} and 1^{st} bits of storage cells as shown in FIG. 4.

Moreover, the first embodiment stated above may also be applied to any kind of MLC non-volatile memory. Taking a 4LC non-volatile memory, where any storage cell stores 2 bits, as an example. The page jumper only selects the LSB page formed from the least significant bit (LSB) of the 2 bits to be stored in one temporary data storage block, and selects the MSB page formed from the most significant bit (MSB) of the 2 bits to be stored in the other temporary data storage block.

By the page jumping stated above, the data writing speed of the computer system is increased, but the capacity of the data storage block becomes smaller.

Also shown in FIG. 4, when the page jumper selects at least a set of bit page in mapping to a physical page, a bypass path is kept. The bypass path simultaneously maps the 0, 1 and 2^{th} order bit pages. When the page jumper selects the bypass path, namely, it skips the jumping of the 0^{th}, 1^{st} and 2^{th} order bit pages, thus the capacity of the original data storage block can be obtained.

It should be noted that during the process of data reading of the computer system for a data storage block, the pages of the data storage block are substantially continuous if the pages stored in the temporary data storage blocks are merged into a data storage block. However, if the pages stored in the temporary data storage blocks are not merged into a data storage block in time, the computer system may still reads these temporary data storage blocks. Moreover, as a person skilled in the art can know, when performing data programming for the data storage pages, the programming process is in the sequence of page addresses from the minimum to the maximum one without page jumper.

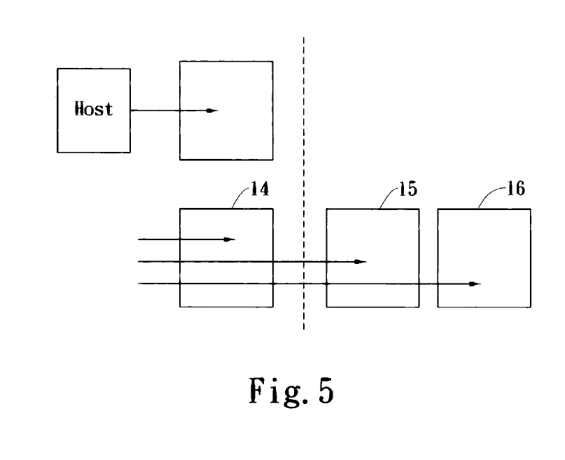

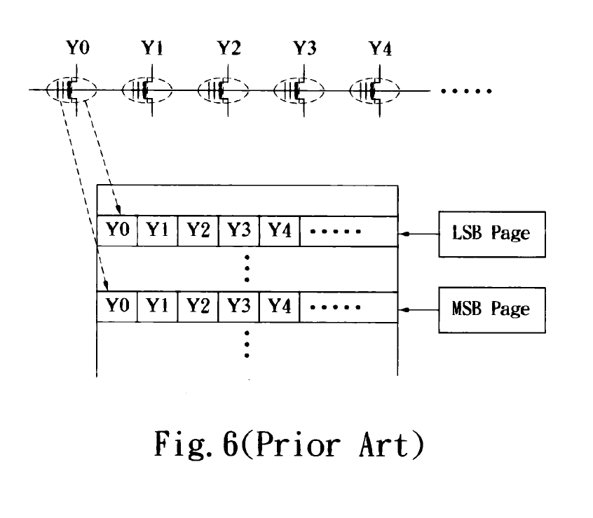

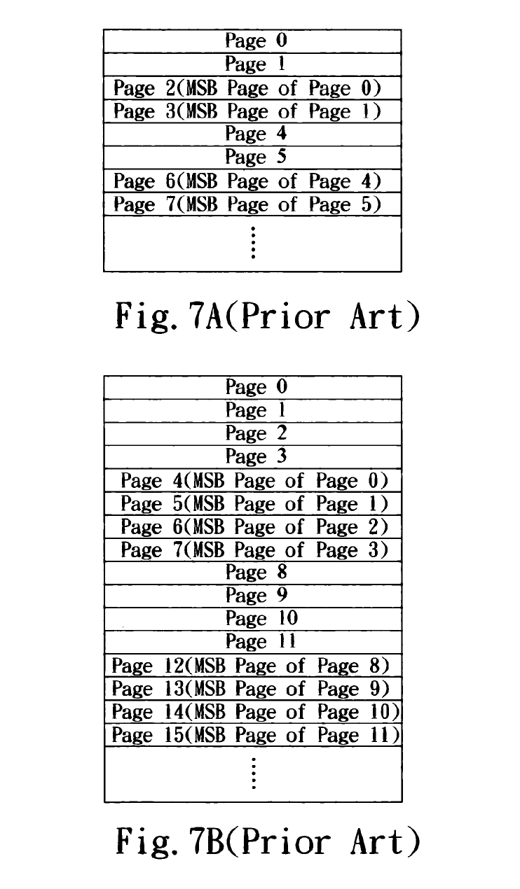

Pease refer to FIG. 5 showing a second preferred embodiment of the present invention, in which, data storage blocks (15, 16) are used as data backup blocks when a computer system is accessing a MLC non-volatile memory. Taking an 8LC non-volatile memory as an example, when the computer system is programrning the data storage pages from minimum to maximum page, it uses 3 data storage blocks (14, 15, 16) of which the data storage block 14 includes all the data of the 0, 1 and 2^{th} order bit pages that the computer system is accessing, while the other two data backup blocks (15, 16) respectively back up the data of the 0 and 1^{th} order bit pages by jumping of a page jumper.

Thereby when the data that the computer system is accessing onto the data storage block 14 are wrong, corresponding data storage pages in the two data backup blocks (15, 16) for backing up can be read, such that correct data can be obtained. After the computer system changes to another data storage block for accessing, it erases the data stored in the data backup blocks (15, 16). Further, before erasing the data stored in the data backup blocks (15, 16), the data stored in the data storage block 14 are verified to assure the data correctness when the computer system is accessing the 8LC non-volatile memory.

Therefore, the present embodiments have the following advantages:
1. A page jumper provided in the present embodiments is selectable, namely, one can select the fastest programming speed and a 0^{th} order bit page or an LSB page with the best reliability, and renders the normally used data storage block to only use the LSB page, in order to reduce the frequency of erasing of the data storage block, thereby the life of use of the data storage block can be elongated, and the life of use of the multi-level cell type non-volatile memory can be elongated too.
2. By jumping of a page jumper, the data that the computer system is accessing continuously are stored in temporary data storage blocks, and then they are merged in a dean block having integrity of data. Therefore, potentially damaging of data in accessing and data accessed originally during accessing of the MLC non-volatile memory can be avoided when an abnormal system power breaking is induced, this can assure integrity of the data in accessing.

In conclusion, according to the description disclosed above, the present invention surely can get the expected object thereof to provide a method for increasing reliability of data accessing for a multi-level cell type non-volatile memory, this not only reduces the frequency of erasing of flash memory blocks to elongate the life of use of the multi-level cell type non-volatile memory, but also assures integrity of the data in accessing.

While the embodiments given are only for illustrating the technical measures of the present invention; it will be apparent to those skilled in this art that various equivalent modifications or changes without departing from the spirit of this invention shall also fall within the scope of the appended claims.

1. A data accessing method for a multi level cell type non-volatile memory, including a plurality of storage cells, each storage cell has 0^{th}˜M^{th} bits, each K^{th} bit of the storage cells respectively form a K^{th} order bit page, wherein 0≦K≦M, the data accessing method comprising:
mapping a logical page onto a plurality of physical pages when a computer system is going to access the multi-level cell type non-volatile memory;
taking a plurality of temporary data storage blocks of the multi-level cell type non-volatile memory for data accessing by the computer system based on the multi-level cell type non-volatile memory; and
providing a page jumper to only select the K^{th} order bit page of physical pages to store in one temporary data storage block.

2. The data accessing method of claim 1, further comprising;
providing the page jumper to select the (K+1)^{th} order bit page of physical pages to store in another temporary data storage block.

3. The data accessing method of claim 2, further comprising:
merging the K^{th} order bit pages and the (K+1)^{th} order bit pages stored in the temporary data storage blocks in a dean block of the multi level cell type non-volatile memory.

4. The data accessing method of claim 3, further comprising:
erasing the K^{th} order bit pages and the (K+1)^{th} order bit pages stored in the temporary data storage blocks.

5. A data accessing method for a multi level cell type non-volatile memory, including a plurality of storage cells, each storage cell has 0^{th}˜M^{th} bits, each K^{th} bit of the storage cells respectively form a K^{th} order bit page, wherein 0≦K≦M, the data accessing method comprising:
mapping a logical page onto a plurality of physical pages when a computer system is going to access the multi-level cell type non-volatile memory;
taking a data storage block to store each 0^{th}˜M^{th} order bit pages;
taking a plurality of data backup blocks of the multi-level cell type non-volatile memory for data accessing by the computer system based on the multi-level cell type non-volatile memory; and
providing a page jumper to only select the K^{th} order bit page of physical pages to store in one data backup block.

6. The data accessing method of claim 5, further comprising:
providing the page jumper to select the (K+1)^{th} order bit page of physical pages to store in another data backup block.

7. The data accessing method of claim 6, further comprising:
erasing the K^{th} order bit pages and the (K+1)^{th} order bit pages stored in the data backup blocks after the computer system verifies data correctness of the data storage block.
